(19) United States
(12) Patent Application Publication
(10) Pub. No.: US 2025/0283356 A1
(43) Pub. Date: Sep. 11, 2025

(54) ELECTRIFIED VEHICLE

(71) Applicant: TOYOTA JIDOSHA KABUSHIKI KAISHA, Toyota-shi (JP)

(72) Inventors: Masaru KIMURA, Toyota-shi (JP); Kohei OHNISHI, Toyota-shi (JP)

(73) Assignee: TOYOTA JIDOSHA KABUSHIKI KAISHA, Toyota-shi (JP)

(21) Appl. No.: 18/976,906

(22) Filed: Dec. 11, 2024

(30) Foreign Application Priority Data
Mar. 7, 2024 (JP) 2024-034996

(51) Int. Cl. E05B 81/08; B60L 50/64; B60L 53/80; E05B 81/18; E05B 81/28; E05B 83/00; H01M 50/249; H01M 50/262; H01M 50/271; H01M 50/574

(52) U.S. Cl. CPC E05B 81/08; B60L 50/64; B60L 53/80; E05B 81/18; E05B 81/28; E05B 83/00; H01M 50/249; H01M 50/262; H01M 50/271; H01M 50/574; H01M 2220/20

(57) ABSTRACT

The disclosed electrified vehicle includes at least one replaceable battery, an electric motor that exchanges electric power with the battery, a battery case, and a locking device, wherein the battery case includes a case body having an opening through which the battery is inserted and removed, and a lid that opens and closes the opening of the case body, and wherein the locking device locks the lid of the battery case in a non-openable manner when at least an electrified vehicle start-up switch is turned on.

### CROSS-REFERENCE TO RELATED APPLICATION

This application claims priority to Japanese Patent Application No. 2024-034996 filed on Mar. 7, 2024, incorporated herein by reference in its entirety.

### BACKGROUND

### 1. Technical Field

The present disclosure relates to an electrified vehicle that can travel by power from an electric motor that exchanges electric power with a replaceable battery.

### 2. Description of Related Art

Hitherto, there has been known a saddle-ride type electrified vehicle including a battery housing portion that is provided below a floor where an occupant places feet and that removably houses a battery (see, for example, Japanese Unexamined Patent Application Publication No. 2013-208962 (JP 2013-208962 A)). A lid member of the battery housing portion is integrated with the upper surface of the battery of the saddle-ride type electrified vehicle to form the floor. A power supply connector and a striker are provided on the lower surface of the battery. The battery housing portion is provided with a power receiving connector to which the power supply connector is connected, and a latch for fixing the striker. Thus, when the battery is lowered into the battery housing portion by gripping the lid member, the power supply connector is connected to the power receiving connector and the striker is fixed to the latch. When the striker and the latch are disengaged by operating a main key, the power supply connector can be detached from the power receiving connector by lifting the lid member, and the battery can be removed together with the lid member.

### SUMMARY

In the related-art saddle-ride type electrified vehicle, the battery can be removed when the user disengages the striker and the latch by operating the main key. However, it is not appropriate to allow the battery to be removed in all cases from the viewpoint of safety.

In view of the above, it is a main object of the present disclosure to satisfactorily ensure safety when a battery is replaced in an electrified vehicle that can travel by power from an electric motor that exchanges electric power with the replaceable battery.

An electrified vehicle of the present disclosure includes at least one replaceable battery and an electric motor configured to exchange electric power with the battery, and is configured to travel by power from the electric motor. The electrified vehicle includes:
a battery case including a case body having an opening into which the battery is to be inserted or removed, and a lid configured to open or close the opening of the case body; and
a locking device configured to lock the lid in an unopenable manner at least when a start switch of the electrified vehicle is ON.

In the electrified vehicle of the present disclosure, the lid of the battery case that houses the replaceable battery is locked in the unopenable manner at least when the start switch of the electrified vehicle is ON. In the electrified vehicle, there is a case where a closed circuit including the battery is or may be formed. In this case, it is possible to satisfactorily reduce the occurrence of a case where an operator who intends to replace the battery touches the battery. As a result, in the electrified vehicle of the present disclosure, it is possible to satisfactorily ensure safety when the battery is replaced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram illustrating an electrified vehicle of the present disclosure;

FIG. 2 is a schematic configuration diagram illustrating a battery case included in the disclosed electrified vehicle;

FIG. 3 is a perspective view of a battery case locking device included in the disclosed electrified vehicle;

FIG. 4 is a control diagram of the disclosed electrified vehicle; and

FIG. 5 is a time chart for explaining a welding determination process of a battery relay in electrified vehicle of the present disclosure.

### DETAILED DESCRIPTION OF EMBODIMENTS

Embodiments of the present disclosure will now be described with reference to the drawings.

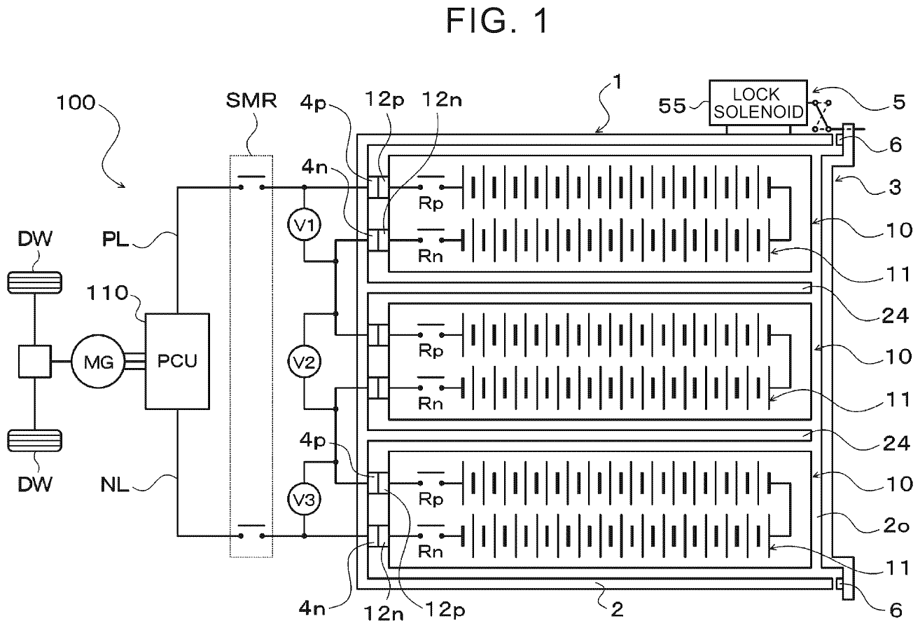

FIG. 1 is a schematic configuration diagram illustrating an electrified vehicle 100 of the present disclosure. Electrified vehicle 100 shown in the drawing is a battery electric vehicle (BEV) including a plurality of replaceable batteries 10, a system main relay SMR which is a normally open mechanical relay (reed relay), a power control device (hereinafter referred to as “PCU”) 110, and a motor-generator MG. PCU 110 includes an inverter (drive circuitry) that drives the motor-generator MG, a boost converter, a DC/DC converter, and the like. The motor-generator MG is a synchronous generator motor (three-phase AC motor).

The rotor of the motor-generator MG is coupled to a drive shaft that rotates integrally with a drive wheel DW via a power transmission including a reduction gear and a differential gear. The motor-generator MG is driven by electric power from PCU 110 (battery 10) and outputs a driving torque (driving force) to the drive wheel DW. In addition, the motor-generator MG outputs regenerative braking torque to the drive wheel DW at the time of braking electrified vehicle 100, and electric power generated (regenerated) by the motor-generator is stored in the batteries 10.

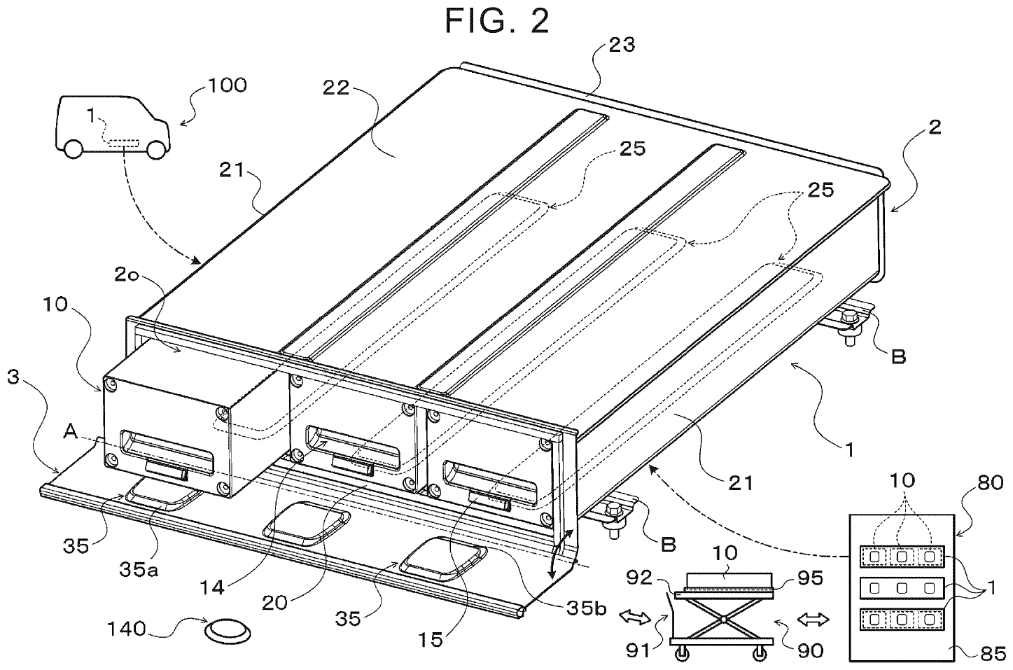

In the present embodiment, electrified vehicle 100 is a commercial vehicle used for, for example, delivery of baggage. The batteries 10 mounted on electrified vehicle 100 are replaced with fully charged batteries 10 charged by a battery charging device 80 (see FIG. 2) outside the vehicle in response to a decrease in SOC. The battery charging device 80 is installed in a collection and delivery station of a baggage, a parking facility of an electrified vehicle 100, or the like. In addition, in a collection and delivery station or the like, the batteries 10 are taken in and out of electrified vehicle 100 or the battery charging device 80 by using the battery transport carriage 90 (see FIG. 2).

The batteries 10 each include a pack case having a substantially rectangular parallelepiped shape and a plurality of battery cells 11 accommodated in the pack case, and have the same specifications (including dimensions) as each other. The battery cell 11 of each battery 10 is, for example, a lithium ion secondary battery cell or a nickel hydrogen secondary electron cell. In the present embodiment, the battery cells 11 are connected in series in the pack case to form a cell stack. In addition, the positive terminal of the cell stack is electrically connected to the positive-electrode-side connector 12p via a mechanical (reed) battery relay Rp. The negative terminal of the cell stack is electrically connected to the negative-electrode-side connector 12n via a mechanical battery relay Rn.

As shown in FIG. 1, electrified vehicle 100 includes a battery case 1 in which (in the present embodiment, for example, three) replaceable batteries 10 are accommodated in a parallel-arranged manner. The battery case 1 is fixed on the floor panel (vehicle body) of electrified vehicle 100 via a plurality of brackets B (see FIG. 2) so as to be positioned behind the front seat of electrified vehicle 100, for example. Thus, the battery accommodating portion of electrified vehicle 100 is defined. The battery case 1 includes a bottomed rectangular tubular case body 2 having an opening 2o, and a cover 3 that opens and closes an opening 2o of the case body 2. In the present embodiment, the case body 2 of the battery case 1 is fixed to the floor panel such that the opening 2o faces, for example, a side surface of electrified vehicle 100 on the driver's seat side.

Inside the case body 2 of the battery case 1, a plurality of positive-electrode-side receptacles 4p that can be coupled to the positive-electrode-side connector 12p of the corresponding battery 10 and a plurality of negative-electrode-side receptacles 4n that can be coupled to the negative-electrode-side connector 12n of the corresponding battery 10 are disposed. The batteries 10 are connected in series via two sets of positive-side receptacles 4p and negative-electrode-side receptacles 4n electrically connected to each other. Further, the positive-electrode-side receptacle 4p that is not connected to the negative-electrode-side receptacle 4n is electrically connected to the positive-electrode-side power line PL via the positive-electrode-side relay of the system main relay SMR. The negative-electrode-side receptacle 4n that is not connected to the positive-electrode-side receptacle 4p is electrically connected to the negative-electrode-side power line NL via the negative-electrode-side relay of the system main relay SMR. Further, the positive-electrode-side power line PL and the negative-electrode-side power line NL are electrically connected to PCU 110. When the system main relay SMR is closed, PCU 110 is electrically connectable to the batteries 10. In addition, voltage sensors V1, V2, V3 are installed in the vicinity of the battery case 1 of the floor panel of electrified vehicle 100 or in the battery case 1. The voltage sensors V1, V2, V3 each detect a voltage across the positive-electrode-side receptacle 4p and the negative-electrode-side receptacle 4n disposed in the back case of the corresponding battery 10.

As shown in FIG. 2, the case body 2 of the battery case 1 is formed of, for example, a plurality of metal plates that is press-processed. The case body 2 includes a bottom portion 20, a pair of side wall portions 21 extending upward from corresponding side edges of the bottom portion 20, a ceiling portion 22 facing the bottom portion 20 at a distance from each other, and an end wall portion 23. The bottom portion 20, the pair of side wall portions 21, and the ceiling portion 22 form a flat square tube, and the end wall portion 23 closes one end portion of the square tube. As a result, a rectangular opening 2o is defined at the end of the case body 2 that faces away from the end wall portion 23. In addition, the positive-electrode-side receptacles 4p and the negative-electrode-side receptacles 4n are disposed so as to be respectively close to the end wall portion 23. Note that the bottom portion 20 and the pair of side wall portions 21 of the case body 2 may be integrally formed, or they may be separately formed and fixed to each other.

Inside the case body 2, (three) batteries 10 are accommodated so as to be aligned along the longitudinal direction (widthwise direction) of the opening 2o as the inserting opening. That is, the batteries 10 are inserted into and removed from the case body 2 through the opening 2o in the extending direction of the pair of side wall portions 21. In addition, a plurality of partition walls 24 (see FIG. 1) is disposed inside the case body 2 so as to be positioned between adjacent batteries 10. Furthermore, the case body 2, in order to be accommodated by easily positioning the battery 10 with respect to the battery case 1, a plurality of (in this embodiment, for example, three) case-side guide portion 25 having the same height and width of each other is provided in the case body 2.

As shown in FIG. 2, the case-side guide portions 25 are disposed at the bottom portion 20. That is, the case-side guide portions 25 extend from the opening 2o side toward the end wall portion 23 side (the inside of the case body 2) in parallel to the respective side wall portions 21, and are spaced apart from each other in the longitudinal direction (widthwise direction) of the opening 2o. In the present embodiment, each case-side guide portion 25 is formed by press working so as to protrude from the inner surface (upper surface) of the bottom portion 20, which is the inner bottom surface of the case body 2, toward the inner side of the case body 2, that is, toward the ceiling portion 22. Each case-side guide portion 25 is located below the central portion in the width direction of each battery 10 accommodated in the case body 2. Further, the upper surface of each case-side guide portion 25 is formed flat, the end portion on the opening 2o side and the end portion on the end wall portion 23 side of each case-side guide portion 25, an inclined surface for continuing the inner surface of the upper surface and the bottom portion 20 is formed.

The lid 3 is formed of, for example, a pressed metal plate, and is rotatably supported around the rotation axis A (see FIG. 2) by the case body 2 via a plurality of hinges (not shown). The rotation axis A extends along a lower edge of the opening 2o, i.e., along one side of the bottom portion 20 defining the opening 2o. As a result, the lid 3 is rotated from the top to the bottom around the rotation axis A (tilted toward the front), whereby the lid 3 can be opened to expose the opening 2o. Further, by rotating (flipping up) the lid 3 from the bottom to the top around the rotation axis A, the lid 3 can be closed and the opening 2o can be closed.

Further, as shown in FIG. 2, the lid 3, so as to align with the case-side guide portion 25 corresponding when the lid 3 is opened (fully opened), a plurality of (in the present embodiment, for example, three) lid side guide portions 35 having the same height and width are disposed. The lid-side guide portions 35 are formed by press working so as to project from the inner surface of the lid 3 toward the inner side of the case body 2 and to be arranged at intervals in the longitudinal direction (width direction) of the lid 3. The lid-side guide portions 35 are located below the central portion in the width direction of each battery 10 to be inserted and removed from the case body 2. Further, the upper surface of each lid-side guide portion 35 is formed flat, and is included in substantially the same plane as the upper surface of the case-side guide portion 25 corresponding to when the lid 3 is opened (fully opened). Further, the end portion on the free end side of the lid 3 of the lid-side guide portion 35, the inclined surface 35a for continuing the inner surface of the lid 3 and the upper surface of the lid-side guide portion 35 is formed. An inclined surface 35b for continuing the upper surface of the lid-side guide portion 35 and the inner surface of the lid 3 is formed at an end portion of the lid-side guide portion 35 on the rotation axis A side.

Each battery 10 includes a guided portion (not shown) that engages with the case-side guide portion 25 of the case body 2 and the lid-side guide portion 35 of the lid 3. In the present embodiment, the guided portion is a pair of ridges (rails) protruding downward from the bottom surface of the battery 10 (pack case) and extending in the longitudinal direction of the battery 10. The pair of ridges extend parallel to each other at a distance slightly larger than the width of the case-side guide portion 25 and the lid-side guide portion 35, and are in sliding contact with the corresponding side surfaces of the case-side guide portion 25 and the lid-side guide portion 35 and the inner surface of the bottom portion 20, respectively. Further, a contact member 15 (see FIG. 2) formed of an elastic body such as rubber or resin is provided on at least one end face of each battery 10 (pack case). The contact member 15 is disposed below the handle portion 14 of the battery 10, and has a surface inclined so as to be separated from the end surface of the battery 10 from the upper surface side toward the bottom surface side of the battery 10.

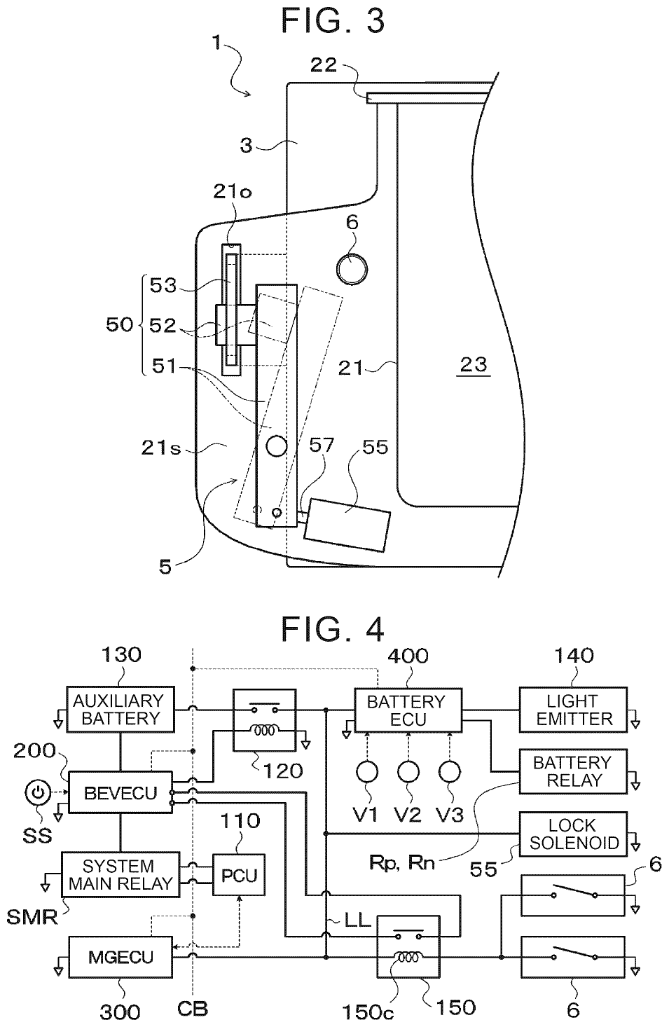

In addition, the case body 2 of the battery case 1 is provided with a locking device 5 that locks the lid 3 with the opening 2o closed so as not to be opened, and two courtesy switches 6 that detect the opening and closing of the lid 3. As shown in FIG. 3, the locking device 5 includes a locking mechanism 50 and a lock solenoid 55 that drives the locking mechanism 50 to form a locked state in response to energization. The locking mechanism 50 selectively forms an unlocked state (refer to a two-dot chain line in the drawing) that allows the lid 3 to be opened, and a locked state (refer to a solid line in the drawing) that restricts the lid 3 from being opened.

The locking mechanism 50 of the locking device 5 includes a locking lever 51 and an engaged portion 53 fixed to the lid 3. The locking lever 51 is disposed on the end wall portion 23 side (front side in FIG. 3) of the support portion 21s supported by the one side wall portion 21 of the case body 2 so as to extend parallel to the closed cover 3. In addition, a central portion of the locking lever 51 in the longitudinal direction is rotatably supported by the support portion 21s about an axis extending in parallel to the side wall portion 21. The engaged portion 53 is fixed to one end of the lid 3 so as to be inserted into an opening 210 formed in an outer end portion of the support portion 21s when the lid 3 is closed (fully closed). Further, at one end (upper end) of the locking lever 51, an engaging portion 52 engageable with the engaged portion 53 of the cover 3 inserted into the opening 210 is formed.

The lock solenoid 55 is a pull solenoid that draws a plunger connected to the shaft 57 into the coil in response to energization. The lock solenoid 55 is fixed to the end wall portion 23-side surface of the support portion 21s such that the shaft 57 protrudes outward from the side wall portion 21. The shaft 57 of the lock solenoid 55 is rotatably coupled to the other end (lower end) of the locking lever 51 via a pin coupling portion. As a result, the lid 3 is closed (fully closed). At the same time, when a current is supplied to the lock solenoid 55 (coil), the engaging portion 52 of the locking lever 51 rotates toward the opening 210 in response to the shaft 57 being drawn toward the coil side, and engages with the engaged portion 53 protruding from the opening 210 toward the end wall portion 23 side. As a result, while the lock solenoid 55 is energized, the lid 3 is unlocked by the locking device 5. It should be noted that the locking device 5 may include a push solenoid.

The two courtesy switches 6 are attached to the other side wall portion 21 of the support portion 21s or the case body 2 so as to be able to abut the corresponding one of both end portions of the cover 3. Each of the courtesy switches 6 is a push-type opening/closing switch that is pressed and closed by the closed lid 3 and is opened in response to opening of the lid 3. Further, in the present embodiment, each of the courtesy switches 6 is grounded so as to form a closed circuit when closed.

The battery case 1 configured as described above is also used in the battery charging device 80. That is, in the housing 85 of the battery charging device 80, a plurality of battery cases 1 are arranged, for example, in the vertical direction so as to define a battery accommodating portion of the battery charging device 80 (see FIG. 2). In addition, in the present embodiment, the battery transport carriage 90 includes a battery mounting plate 95 corresponding to a case in which both of the pair of side wall portions 21 are partially removed from the bottom portion 20 of the case body 2 integrated with the pair of side wall portions 21. The battery transport carriage 90 includes a carriage body 91 including a base frame, a plurality of casters, a handle, and the like, and a top plate 92. The casters are at least three casters. The top plate 92 is supported by a carriage body 91 (base frame) so as to be movable up and down via an elevating mechanism (lifter). The battery mounting plate 95 is supported by the top plate 92 (the carriage body 91).

FIG. 4 is a control diagram of electrified vehicle 100. As shown in the drawing, electrified vehicle 100 includes an overall electronic control unit (hereinafter referred to as “BEVECU”) 200, a motor electronic control unit (hereinafter referred to as “MGECU”) 300 for controlling PCU 110, and a battery electronic control unit (hereinafter referred to as “battery ECU”) for managing the batteries 10. Each of BEVECU 200, MGECU 300 and the battery ECU 400 includes a microcomputer having a CPU, ROM, RAM, an input/output interface, and the like (not shown), various driving circuitry, various logic IC, and the like. BEVECU 200, MGECU 300 and the battery ECU 400 exchange data (communication frames) with each other via a shared communication line (CAN bus) CB or the like.

Various sensors such as a start switch (IG switch) SS, an accelerator pedal position sensor, a shift position sensor, and a vehicle speed sensor are connected to BEVECU 200. When electrified vehicle 100 is traveling, BEVECU 200 sets a required torque required for traveling on the basis of the accelerator operation amount and the vehicle speed. At the same time, BEVECU 200 sets a torque command or the like for the motor-generator MG based on the required torque or the like. Further, BEVECU 200 controls opening and closing of the system main relay SMR and the power supply relay (IGCT relay) 120.

The power supply relay 120 is a normally open mechanical relay (reed relay). The power supply relay 120 is capable of electrically connecting the auxiliary battery (low voltage battery) 130 of electrified vehicle 100, DC/DC converters of PCU 110, and the low voltage power line LL. The auxiliary battery 130 has a rated output-voltage of, for example, about 12 V. The low voltage power line LL is connected to a plurality of accessories including a MGECU 300, a battery ECU 400, and the like. A driver of the electrified vehicle 100 turns on a start switch SS, so that a start-up request of the electrified vehicle 100 is made. Then, BEVECU 200 supplies an exciting current based on electric power from the auxiliary battery 130 or the like to the coil of the power supply relay 120 to close the power supply relay 120. By closing the power supply relay 120, electric power from the auxiliary battery 130 or the like is supplied to the various auxiliary machines.

Further, BEVECU 200 closes the power supply relay 120 and then executes predetermined processes such as the welding determination, the overheat determination, and the electric leakage determination of the system main relay SMR. When the predetermined ready-on condition is satisfied, BEVECU 200 closes the system main relay SMR. In this situation, BEVECU 200 supplies the excitation current based on the electric power from the auxiliary battery 130 or the like to the coils of the system main relay SMR (the positive-side relay and the negative-electrode-side relay) to close the system main relay SMR. When the system is started up, failures such as welding (closing failure) of the system main relay SMR may have occurred. BEVECU 200 turns on a predetermined warning light on the display provided on the instrument panel and shifts electrified vehicle 100 to the corresponding fail safe mode.

Further, BEVECU 200 shuts off the excitation current and opens the system main relay SMR when the driver turns off the start switch SS and requires electrified vehicle 100 to be shut down. Thereafter, BEVECU 200 executes predetermined processes such as the welding determination, the overheat determination, and the electric leakage determination of the system main relay SMR, and when the predetermined conditions are satisfied, shuts off the supplying of the excitation current and opens the power supply relay 120. If a fail occurs, such as welding of the system main relay SMR, when system shutdown is requested, BEVECU 200 turns on the predetermined fail flag and then shuts down electrified vehicle 100. Electrified vehicle 100 then transitions to fail safe mode when the start switch SS is turned on next time. In electrified vehicle 100, the display of the instrument panel is turned off when the start switch SS is turned off.

As illustrated in FIG. 4, the battery ECU 400 acquires detected values of the voltage sensors V1, V2, V3 provided for each of the batteries 10. Further, the battery ECU 400 is electrically connected to the battery relays Rp, Rn of the respective batteries 10 via connectors and receptacles (not shown) and a power supply line. While the power supply relay 120 is closed, the battery ECU 400 supplies an exciting current to the coils of each battery relay Rp, Rn to close each battery relay Rp, Rn. The excitation current is based on electric power supplied from the auxiliary battery 130 or the like via the power supply relay 120. Further, the battery ECU 400 may cut off the energization current to open the respective battery relays Rp, Rn. When at least one of the battery relays Rp, Rn is opened, even if the system main relay SMR is closed, the batteries 10, a PCU 110, a motor-generator MG, and the like are included (closed circuit).

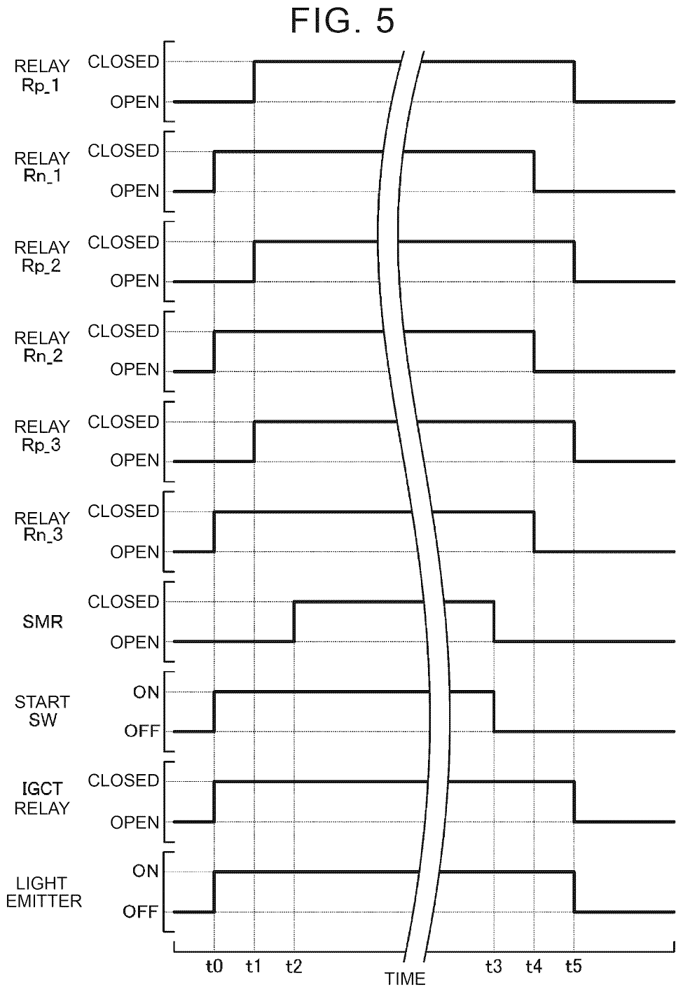

Further, the battery ECU 400, after the power supply relay 120 is closed in response to the start switch SS is turned on (and before the system main relay SMR is closed), and after the system main relay SMR is opened in response to the start switch SS being turned off, to determine whether or not there is welding (closing failure) of the battery relays Rp, Rn of the respective batteries 10. That is, when the start switch SS is turned on and the power supply relay 120 is closed, the battery ECU 400 determines whether one of the battery relays Rp, Rn (for example, the battery relay Rp) of the respective batteries 10 is welded, as illustrated in FIG. 5. Note that the relays Rp_1 and Rn_1 in FIG. 5 indicate the battery relays Rp, Rn of the first battery 10. The relays Rp_2 and Rn_2 indicate the battery relays Rp, Rn of the second battery 10. The relays Rp_3 and Rn_3 indicate the battery relays Rp, Rn of the third battery 10.

Specifically, when the power supply relay 120 is closed, the battery ECU 400 closes only the other of the battery relays Rp, Rn (for example, the battery relay Rn) of the respective batteries 10 (time to in FIG. 5). The battery ECU 400 determines whether one of the battery relays Rp, Rn of the respective batteries 10 is welded based on the detected value of the voltage sensors V1, V2, V3. When the detected values of the voltage sensors V1, V2, V3 are all zero, the battery ECU 400 as the failure determination device determines that one of the battery relays Rp, Rn of each battery 10 is not welded, and closes one of the battery relays Rp, Rn of each battery 10. At the same time, the battery ECU 400 transmits a notification of permission to close the system main relay SMR to BEVECU 200 (time t1 in FIG. 5). In this case, BEVECU 200 closes the system main relay SMR on condition that the system main relay SMR or the like is normal (time t2 in FIG. 5). On the other hand, the battery ECU 400 may determine that at least one of the battery relays Rp, Rn of the respective batteries 10 is welded based on the detected value of the voltage sensors V1, V2, V3. In this case, the battery ECU 400 turns on a predetermined warning light on the display provided on the instrument panel and shifts electrified vehicle 100 to the corresponding fail safe mode.

Further, when the start switch SS is turned off and the system main relay SMR is opened (time t3 in FIG. 5), the battery ECU 400 determines whether or not the other of the battery relays Rp, Rn (for example, the battery relay Rn) of the respective batteries 10 is welded. Specifically, when the system main relay SMR is opened, the battery ECU 400 opens only the other of the battery relays Rp, Rn of the respective batteries 10 (time t4 in FIG. 5). The battery ECU 400 determines whether the other of the battery relays Rp, Rn of the respective batteries 10 is welded based on the detected values of the voltage sensors V1, V2, V3. When the detected values of the voltage sensors V1, V2, V3 are all zero, the battery ECU 400 as the failure determination device determines that the other of the battery relays Rp, Rn of the respective batteries 10 is not welded. The battery ECU 400 opens one of the battery relays Rp, Rn of the respective batteries 10 and transmits a notification of opening permission of the power supply relay 120 to BEVECU 200 (time t5 in FIG. 5). Upon receiving the opening permission notification from the battery ECU 400, BEVECU 200 opens the power supply relay 120 on condition that the system main relay SMR or the like is normal.

Further, as shown in FIG. 4, the lock solenoid 55 (coil) of the locking device 5 of the battery case 1 is connected to the low voltage power line LL. While the power supply relay 120 is closed, a current from the auxiliary battery 130 or the like is constantly supplied to the lock solenoid 55. As a result, while the power supply relay 120 is closed, the lock solenoid 55 holds the locking lever 51 of the locking mechanism 50 so that the engaging portion 52 is engaged with the engaged portion 53 inserted into the opening 210. As a consequence, the cover 3 of the battery case 1 is unlocked by the locking device 5 while the start switch SS is turned on and the power supply relay 120 is closed.

Furthermore, as shown in FIG. 4, the two courtesy switches 6 of the battery case 1 are electrically connected to one end of a coil 150c of an interlock relay (circuit opening and closing relay) 150 via a connector and a receptacle (not shown) and an electric wire. The interlock relay 150 is a mechanical relay (reed relay). The other end of the coil 150c of the interlock relay 150 is connected to the low voltage power line LL. One of the two contacts of the interlock relay 150 is electrically connected to the first terminal of BEVECU 200, and the other of the two contacts is electrically connected to the second terminal of BEVECU 200. BEVECU 200 applies a voltage based on electric power from the auxiliary battery 130 or the like to the first terminal during a period from when the start switch SS is turned on to when it is turned off.

When the cover 3 of the battery case 1 is closed and at least one of the two courtesy switches 6 is closed, one end of the coil 150c of the interlock relay 150 is grounded by the courtesy switch 6. Therefore, when the cover 3 of the battery case 1 is closed and the power supply relay 120 is closed, an excitation current based on electric power from the auxiliary battery 130 or the like is supplied to the coil 150c, thereby closing the interlock relay 150. When the interlock relay 150 is closed, the first and second terminals of BEVECU 200 are electrically connected via the interlock relay 150. BEVECU 200 compares the voltages of the first and second terminals and determines that the interlock relay 150 is closed if the voltages of the first and second terminals are approximately the same.

On the other hand, when the cover 3 of the battery case 1 is opened, even if the power supply relay 120 is closed, the energization current to the coil 150c is interrupted by the opening of the respective courtesy switches 6, and the interlock relay 150 is opened. The opening of each courtesy switch 6 is the opening of the closed circuit by releasing the ground. Then, the first and second terminals of BEVECU 200 are disconnected from each other, and the voltage of the second terminal becomes zero. BEVECU 200 determines that the lid 3 of the battery case 1 is opened when the voltage of the second terminal drops (drops to zero), and the respective courtesy switches 6 are opened to open the interlock relay 150. BEVECU 200 cuts off supplying the excitation current to the system main relay SMR to open the system main relay SMR. As a result, a high-voltage circuit (closed circuit) including the batteries 10, PCU 110, the motor-generator MG, and the like is opened.

In addition, as shown in FIG. 4, a light emitter 140 as a notification device is electrically connected to the battery ECU 400. The light emitter 140 includes a light emitting diode or the like. The light emitter 140 is installed in front of the lid 3 so as to be identified by an operator (user) who replaces the battery 10 in a state where the lid 3 of the battery case 1 is closed (see FIG. 2). The front of the cover 3 is in the vicinity of the battery case 1 of electrified vehicle 100 floor panel. However, the light emitter 140 may be installed in the battery case 1 as long as it can be identified by an operator in a state where the lid 3 of the battery case 1 is closed. The battery ECU 400 supplies an exciting current to the light emitter 140 to turn on (emit light) the light emitter 140 while the start switch SS is turned on and the power supply relay 120 is closed. The excitation current is based on electric power supplied from the auxiliary battery 130 or the like via the power supply relay 120.

That is, in electrified vehicle 100, the cover 3 of the battery case 1 is unlocked by the locking device 5 while the start switch SS is turned on and the power supply relay 120 is closed. At the same time, the light emitter 140 installed in the vicinity of the battery case 1 is made to emit light. Therefore, the light emitter 140 functions as a notification device that notifies that the lid 3 of the battery case 1 is locked. In addition, the battery ECU 400 can blink the light emitter 140 by intermittently supplying the exciting current.

As described above, electrified vehicle 100 includes the replaceable batteries 10 and a motor-generator MG that exchanges power with the batteries 10. Electrified vehicle 100 can be driven by power from the motor-generator MG. Further, electrified vehicle 100 includes a battery case 1 and a locking device 5. The battery case 1 includes a case body 2 having an opening 2o into which the batteries 10 are inserted and removed, and a cover 3 that opens and closes an opening 2o of the case body 2. The locking device 5 locks the lid 3 in a non-openable manner at least when electrified vehicle 100 starting-switch SS is switched on.

More specifically, the cover 3 of the battery case 1 is locked so as not to be opened while electrified vehicle 100 start switch SS is turned on and the power supply relay 120 is closed. Thus, in electrified vehicle 100, when a high-voltage circuit (closed circuit) including a plurality of batteries 10, a PCU 110, a motor-generator MG, and the like is formed, or when there is a possibility that the high-voltage circuit is formed after the start switch SS is turned on, it is possible to satisfactorily suppress the operator who intends to replace the battery 10 from touching the battery 10. Consequently, electrified vehicle 100 can ensure good safety when replacing the battery 10.

The locking device 5 of the battery case 1 includes a locking mechanism 50 and a lock solenoid 55. The locking mechanism 50 selectively forms an unlocked state in which the opening of the lid 3 is permitted and a locked state in which the opening of the lid 3 is restricted. The lock solenoid 55 drives the locking mechanism 50 so as to form a locked state in response to energization, and the lock solenoid 55 of the locking device 5 is connected to a power source such as the auxiliary battery 130 via a power supply relay 120 that is closed in response to the start switch SS being turned on. Accordingly, the locking device 5 can be reliably operated when the start switch SS is turned on while the control in electrified vehicle 100 is suppressed from becoming complicated.

Further, in electrified vehicle 100, the lock solenoid 55 is supported by the case body 2 of the battery case 1. Further, the locking mechanism 50 includes a locking lever 51 rotatably supported by the case body 2, and the locking lever 51 is rotationally driven by the lock solenoid 55 to engage with the engaged portion 53 provided on the lid 3. Accordingly, the locking device 5 can be integrated with the battery case 1 to further improve the assemblability and versatility of the battery case 1 to electrified vehicle 100. However, the locking device 5 may be installed on an electrified vehicle 100 vehicle body such as a floor panel.

Further, the battery case 1 of electrified vehicle 100 includes a plurality of courtesy switches 6 for detecting opening and closing of the cover 3. The respective courtesy switches 6 are closed when the cover 3 is closed to allow the high-voltage circuit (closed circuit) including the batteries 10, PCU 110, the motor-generator MG, and the like to be closed. At the same time, each of the courtesy switches 6 is opened when the lid 3 is open, and the closing of the high voltage circuit is prohibited. Accordingly, when the lid 3 of the battery case 1 is opened, a high voltage circuit through which a current flows from the battery 10 is not formed, and thus safety at the time of replacement of the battery 10 can be more satisfactorily ensured. However, the battery case 1 may include a single courtesy switch 6.

Further, electrified vehicle 100 includes an interlock relay (circuit opening and closing relay) 150 that opens and closes a high-voltage circuit (closed circuit) including a plurality of batteries 10, a PCU 110, a motor-generator MG, and the like in cooperation with a BEVECU 200. The high-voltage circuitry includes the batteries 10, PCU 110, motor-generator MG, and the like. That is, the interlock relay 150 closes when the exciting current is supplied to the coil 150c to allow the high voltage circuit to be closed, and opens when the exciting current is not supplied to the coil 150c to prohibit the high voltage circuit from being closed. In addition, the respective courtesy switches 6 of the battery case 1 are closed when the cover 3 is closed to allow the exciting current to be supplied to the interlock relay 150 (coil 150c). At the same time, each of the courtesy switches 6 opens when the lid 3 of the battery case 1 is opened, thereby interrupting the supply of the excitation current to the interlock relay 150. Thus, when the lid 3 of the battery case 1 is open, it is possible to more reliably suppress the formation of a high voltage circuit through which a current flows from the batteries 10.

In the above-described embodiment, the interlock relay 150 has a function of notifying BEVECU 200 of the opening/closing status of the cover 3 of the battery case 1, but the present disclosure is not limited thereto. That is, the interlock relay 150 may, for example, interrupt the supplying of the excitation current to the system main relay SMR when the courtesy switch 6 is opened. In addition, instead of installing the voltage sensors V1, V2, V3 in electrified vehicle 100 or the battery case 1 described above, a voltage sensor V1, V2 or V3 may be provided. The voltage sensor V1, V2 or V3 detects a voltage across the positive-electrode-side receptacle 4p and the negative-electrode-side receptacle 4n in the pack case of the corresponding battery 10. Further, a capacitor may be provided between the positive-electrode-side receptacle 4p and the negative-electrode-side receptacle 4n of the respective batteries 10, and a single voltage-sensor may be provided in electrified vehicle 100 or the battery case 1. Further, the batteries 10 may be provided with indicator lights that are turned on when the battery relays Rp or Rn are closed. Further, the battery case 1 may be mounted on a moving object other than an electrified vehicle 100 such as a railcar, or may be installed in a fixed facility other than the battery charging device 80. The battery case 1 may also be configured to accommodate a single replaceable battery 10. Furthermore, the case body 2 of the battery case 1 may be defined by an electrified vehicle 100 vehicle body. A part of the case body 2 may be formed by a part of a vehicle body of electrified vehicle 100.

It is needless to say that the disclosure of the present disclosure is not limited to the above-described embodiments, and various modifications can be made within the scope of the extension of the present disclosure. Furthermore, the above-described embodiment is only a specific form of the disclosure described in the column of the outline of the disclosure, and does not limit the elements of the disclosure described in the column of the outline of the disclosure.

The present disclosure is applicable to the manufacturing industry of electrified vehicle and the like.

What is claimed is:

1. An electrified vehicle that includes at least one replaceable battery and an electric motor configured to exchange electric power with the battery, and that is configured to travel by power from the electric motor, the electrified vehicle comprising:
a battery case including a case body having an opening into which the battery is to be inserted or removed, and a lid configured to open or close the opening of the case body; and
a locking device configured to lock the lid in an unopenable manner at least when a start switch of the electrified vehicle is ON.

2. The electrified vehicle according to claim 1, wherein:
the locking device includes a locking mechanism configured to selectively set an unlocked state in which the lid is allowed to be opened and a locked state in which opening of the lid is restricted, and a solenoid configured to drive the locking mechanism to set the locked state in response to energization; and
the solenoid of the locking device is connected to a power supply via a relay that is closed when the start switch is turned ON.

3. The electrified vehicle according to claim 2, wherein:
the solenoid is supported by the case body; and
the locking mechanism includes a locking lever that is rotatably supported by the case body and rotationally driven by the solenoid to engage with an engaged portion provided on the lid.

4. The electrified vehicle according to claim 1, wherein:
the battery case includes a switch configured to detect opening and closing of the lid; and
the switch is configured to allow closing of a closed circuit including the battery when the lid is closed, and prohibit the closing of the closed circuit when the lid is open.

5. The electrified vehicle according to claim 4, further comprising a circuit opening and closing relay configured to allow the closing of the closed circuit by being closed when an excitation current is supplied, and prohibit the closing of the closed circuit by being opened when the excitation current is not supplied, wherein the switch is configured to allow supply of the excitation current to the circuit opening and closing relay by being closed when the lid is closed, and interrupt the supply of the excitation current to the circuit opening and closing relay by being opened when the lid is opened.
